(19) United States
(12) Patent Application Publication
(10) Pub. No.: US 2009/0194736 A1
(43) Pub. Date: Aug. 6, 2009

(54) Nanosized nickel-doped carbon nanotubes for hydrogen storage and production method thereof

(76) Inventors: Jai-Young Lee, Daejeon (KR); Jeung-Ku Kang, Daejeon (KR); Hyun-Seok Kim, Daejeon (KR); Kyu-Sung Han, Daejeon (KR); Min-Sang Song, Daejeon (KR); Ho Lee, Gyeonggi-do (KR); Jin-Ho Kim, Gyeonggi-do (KR)

Correspondence Address: STERNE, KESSLER, GOLDSTEIN & FOX P.L.L.C., 1100 NEW YORK AVENUE, N.W., WASHINGTON, DC, 20005, US

(21) Appl. No.: 11/396,910

(22) Filed: Apr. 4, 2006

(30) Foreign Application Priority Data
Apr. 12, 2005 (KR) 10-2005-0030370

(51) Int. Cl. C09K 3/00; B01J 13/02

(52) U.S. Cl. 252/182.33; 427/213.31; 977/749

(57) ABSTRACT

Disclosed herein is a method of doping nanosized nickel (Ni) on the surface of carbon nanotubes to improve the hydrogen storage capacity of the carbon nanotubes. The method comprises: sonicating carbon nanotube samples produced by vapor deposition, in sulfuric acid solution, followed by filtration to remove a metal catalyst from the carbon nanotube samples; and doping the carbon nanotube samples in liquid phase solution, followed by drying and reduction, so as to dope nanosized nickel on the surface of the carbon nanotubes.

### CROSS REFERENCE TO RELATED APPLICATIONS

This application claims priority to Korean Patent Appl. No. 10-2005-0030370, filed Apr. 12, 2005, which is incorporated by reference herein in its entirety.

### BACKGROUND OF THE INVENTION

1. Field of the Invention

The present invention relates to carbon nanotubes with improved hydrogen storage capacity and a production method thereof, and more particularly, to a method for doping nanosized nickel (Ni) on the surface of carbon nanotubes.

2. Background Art

Fossil fuels, such as petroleum, coal and natural gas, satisfy more than 90% of the current demand for energy.

However, because such fossil fuels are impossible to recycle after use, if they are consumed at the current rate, fossil fuel reserves will be exhausted within 50-100 years.

In addition, various environmental pollutants resulting from the combustion of fossil fuels threaten the survival of mankind by causing serious environmental problems, such as global warming, ozone depletion and acid rain.

For these reasons, there is a need for the development of inexhaustible, clean and safe alternative energy, and ultimately, the development of new energy systems independent of fossil fuels, such as petroleum.

In light of this, hydrogen energy is receiving the most attention as an ideal alternative energy source.

Fuel cell systems using hydrogen as fuel are advantageous in that they are an inexhaustible resource because it is possible to produce an infinite amount of hydrogen from water, and when used, they discharge no environmental pollutants, such as carbon dioxide (CO₂). However, such fuel cell systems require hydrogen storage media to use hydrogen, and studies into the use of carbon nanotubes as such hydrogen storage media have been recently conducted.

The hydrogen storage mechanism of carbon nanotubes has not yet been clearly established, and carbon nanotubes have a shortcoming in that their hydrogen storage capacity at room temperature is very low.

Ye et al. reported that, among carbon nanotubes, single-wall carbon nanotubes stored 8 wt % hydrogen (Ye et al., Appl. Phys. Lett. 74, 2307 (1999)), but this is a result obtained at a very low temperature of 80 K and a high pressure of 40 bar, and there is still no study reporting a hydrogen storage capacity of more than 1 wt % achieved at room temperature and atmospheric pressure.

### BRIEF SUMMARY OF THE INVENTION

The present inventors have conducted a study of hydrogen storage materials applicable to hydrogen fuel cell systems, and consequently, found that carbon nanotubes having nanosized nickel doped on the surface thereof can absorb and desorb a very large amount of hydrogen at room temperature and atmospheric pressure.

Accordingly, an object of the present invention is to provide a hydrogen storage material with high capability for reversible hydrogen absorption and desorption, which is obtained by doping nanosized nickel on the surface of carbon nanotubes, as well as a production method thereof.

To achieve the above object, the present invention provides a method for producing nanosized nickel-doped carbon nanotubes for hydrogen storage, the method comprising: a pretreatment step of sonicating carbon nanotube samples, prepared by vapor deposition, in a sulfuric acid solution, followed by filtration, so as to remove a metal catalyst from the carbon nanotube samples; and a doping step of impregnating the carbon nanotube samples in liquid phase solution, drying the carbon nanotube solution, and reducing the dried carbon nanotube samples in a hydrogen atmosphere so as to dope nanosized nickel on the surface of the carbon nanotubes.

In the present invention, multiwall carbon nanotubes were used as a hydrogen storage material for hydrogen fuel cells, and liquid phase methods were used to uniformly dope nanosized nickel (Ni) on the surface of carbon nanotubes. The following two methods were used for doping.

In the first method, carbon nanotubes are added to an acetone solution containing a suitable concentration of Ni nitrate (Ni(NO₃)₂) dissolved therein, and the carbon nanotube solution is sonicated, followed by drying at 60° C. The dried sample is reduced in a hydrogen atmosphere at 150° C. for more than 2 hours.

In the second method, carbon nanotubes are dissolved in distilled water containing a suitable concentration of Ni chloride (NiCl₂.6H₂O) and a surfactant (Na₃C₆H₅O₇.2H₂O), followed by stirring for 24 hours. Then, the carbon nanotube solution is reduced by a reducing agent, followed by washing and drying.

In the present invention, the amount of nickel doped on the surface of carbon nanotubes is 1 wt % to 99 wt % based on the weight of the carbon nanotubes.

The particle size of nickel doped on the surface of carbon nanotubes is 1 nm to 1 μm.

The nanosized nickel-doped carbon nanotubes of the present invention have a higher hydrogen absorption and desorption capacity at room temperature than previously described carbon nanotubes, and can store about 2.8 wt % hydrogen at around room temperature. The nanosized nickel-doped carbon nanotubes are expected to be commercialized as a hydrogen storage material for fuel cell systems.

### BRIEF DESCRIPTION OF THE DRAWINGS/FIGURES

The above and other objects, features and advantages of the present invention will be more clearly understood from the following detailed description taken in conjunction with the accompanying drawings, in which:

FIG. 1 is a graphic diagram, showing the hydrogen desorption characteristic of carbon nanotubes at room temperature and atmospheric pressure, from which the fact that carbon nanotubes desorb only 0.09 wt % of hydrogen at around 325 K, can be seen;

FIG. 2 shows transmission electron spectroscopy (TEM) photographs of nickel doped on the surface of carbon nanotubes by the use of varying concentrations of Ni nitrate solutions;

FIG. 2a is a TEM photograph showing that 3 wt % Ni was doped using a 5 mM Ni nitrate (Ni(NO₃)₂) solution;

FIG. 2b is a TEM photograph showing that 6 wt % Ni was doped using a 10 mM Ni nitrate (Ni(NO₃)₂) solution;

FIG. 2c is a TEM photograph showing that 13 wt % Ni was doped using a 21 mM Ni nitrate (Ni(NO₃)₂) solution;

FIG. 2d is a TEM photograph showing that 40 wt % Ni was doped using a 73 mM Ni nitrate (Ni(NO₃)₂) solution;

FIG. 3 is a graphic diagram showing the hydrogen desorption characteristic of carbon nanotubes having nanosized nickel doped on the surface thereof, at around room temperature and atmospheric pressure, from which the fact that a higher hydrogen desorption peak than before doping is observed at around 400 K, and carbon nanotubes doped with 6 wt % Ni using a 10 mM Ni nitrate (Ni(NO₃)₂) solution show a high hydrogen desorption capacity of up to about 2.8 wt %, can be seen;

FIG. 4 is a graphic diagram showing the hydrogen desorption characteristic of carbon nanotubes doped with 6 wt % Ni using a 10 mM Ni nitrate (Ni(NO₃)₂) solution, from which the fact that the carbon nanotubes show a high hydrogen desorption capacity of up to about 2.8 wt % at atmospheric pressure and in a temperature range of 70-220° C. can be seen; and

FIG. 5 shows 3 cycles of hydrogen desorption characteristics for carbon nanotubes doped with 6 wt % Ni using 10 mM Ni nitrate (Ni(NO₃)₂) solution, from which the fact that nanosized nickel functions to increase the reversible hydrogen absorption and desorption of carbon nanotubes, can be seen.

### DETAILED DESCRIPTION OF THE INVENTION

Hereinafter, the present invention will be described in detail using examples and test examples. It is to be understood, however, that these examples are given to more fully describe the present invention, but are not construed to limit the scope of the present invention.

### EXAMPLES

### 1. Production of Carbon Nanotubes and Carbon Nanotube Samples

Carbon nanotube samples are produced by, for example, thermal chemical vapor deposition (thermal CVD), plasma enhanced CVD, laser ablation, or arc discharge.

### 1-1. Production of Carbon Nanotube Samples by Thermal CVD

In the case of using thermal CVD, carbon nanotube samples were produced using argon/hydrogen (Ar/H₂) as reaction gases at a temperature of 800° C. and a pressure range of 100-760 torr with the feeding of a carbon source material and a catalyst material (0.04 g ferrocene per ml of xylene). The carbon nanotubes thus prepared were sonicated in 70% sulfuric acid solution for 3 hours to remove the metal catalyst from the carbon nanotubes, followed by filtration through a filter.

### 1-2. Production of Carbon Nanotube Samples by Plasma Enhanced CVD

In the case of using plasma enhanced CVD, carbon nanotube samples were produced using a mixed gas consisting of 0.1% methane (CH₄), 89.9% hydrogen (H₂) and 10% oxygen (O₂), at a temperature of 750° C., a pressure of 30 torr and a microwave power of 700 W. The carbon nanotubes thus produced were sonicated in 70% sulfuric acid solution for 3 hours, followed by filtration through a filter.

### 2. Production of Carbon Nanotubes Having Nanosized Nickel on the Surface Thereof

0.1 g of the carbon nanotube samples obtained as described above were impregnated in 200 ml of each of acetone solutions containing 73 mM, 21 mM, 10 mM and 5 mM Ni nitrate (Ni(NO₃)₂), respectively, and then stirred for 3 hours, followed by drying at 60° C. The dried samples were reduced in a hydrogen atmosphere at 300° C. for 3 hours, thus producing carbon nanotubes having nanosized nickel doped on the surface thereof.

### 3. Hydrogen Adsorption and Desorption Tests

The carbon nanotube having nanosized nickel doped on the surface thereof, which have been produced as described above, were first degassed at 350° C. in a vacuum (3-10 torr) for more than 6 hours, so as to completely remove gases from the carbon nanotubes. Next, the carbon nanotubes were adsorbed with hydrogen at room temperature and 60 atm for 6 hours, and then maintained at a temperature of −190° C. with liquid nitrogen by a cryostat, thus adsorbing hydrogen.

A hydrogen desorption test for the samples adsorbed with hydrogen as described above was performed by thermal desorption spectrum analysis (TCD).

The samples were heated from −190° C. to 500° C. at a rate of 4.5° C./min while hydrogen desorbed from the samples was analyzed with a gas chromatograph (HP 58.90).

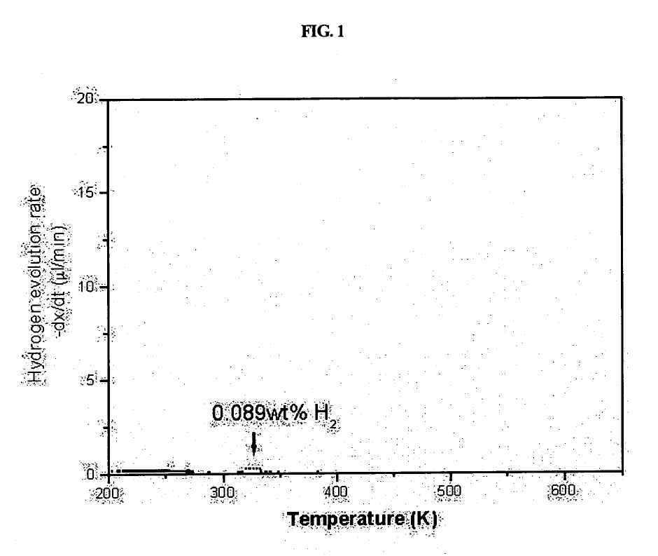

FIG. 1 is a graphic diagram showing the hydrogen desorption characteristic of carbon nanotubes at room temperature and atmospheric pressure. As can be seen in FIG. 1, carbon nanotubes desorb only 0.09 wt % of hydrogen at around 325 K.

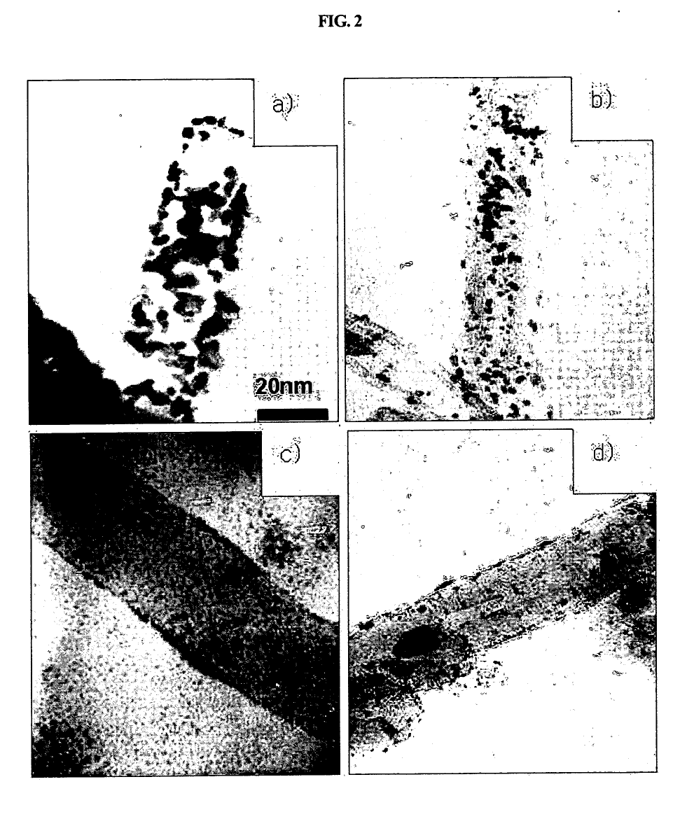

FIG. 2 shows transmission electron spectroscopy (TEM) photographs of nickel doped on the surface of carbon nanotubes by the use of varying concentrations of Ni nitrate solutions.

FIG. 2a is a TEM photograph showing that 3 wt % Ni was doped using a 5 mM Ni nitrate (Ni(NO₃)₂) solution.

FIG. 2b is a TEM photograph showing that 6 wt % Ni was doped using a 10 mM Ni nitrate (Ni(NO₃)₂) solution.

FIG. 2c is a TEM photograph showing that 13 wt % Ni was doped using a 21 mM Ni nitrate (Ni(NO₃)₂) solution.

FIG. 2d is a TEM photograph showing that 40 wt % Ni was doped using a 73 mM Ni nitrate (Ni(NO₃)₂) solution.

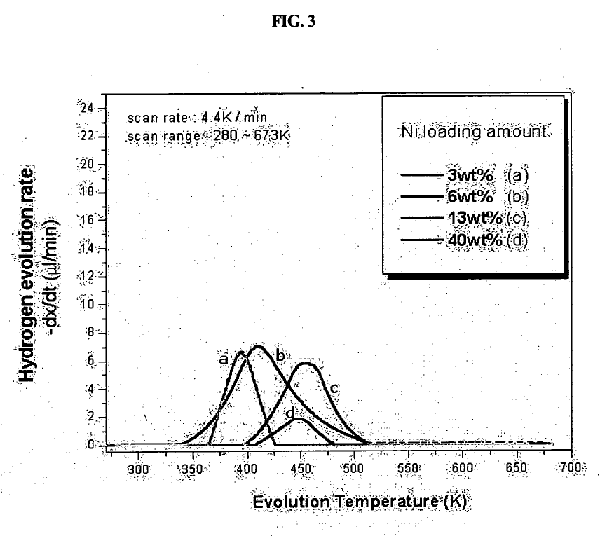

FIG. 3 is a graphic diagram showing the hydrogen desorption characteristic of carbon nanotubes having nanosized nickel doped on the surface thereof, at around room temperature and atmospheric pressure. As can be seen in FIG. 3, a higher hydrogen desorption peak than before doping is observed at around 400 K, and carbon nanotubes doped with 6 wt % Ni using a 10 mM Ni nitrate (Ni(NO₃)₂) solution show a high hydrogen desorption capacity of up to about 2.8 wt %.

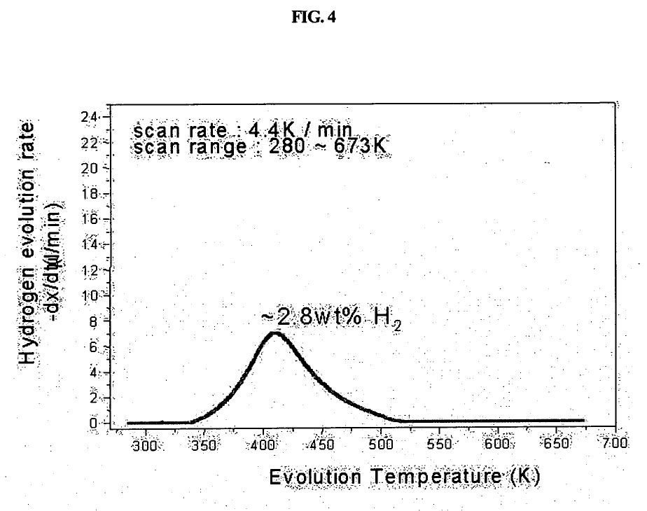

FIG. 4 is a graphic diagram showing the hydrogen desorption characteristic of carbon nanotubes doped with 6 wt % Ni using a 10 mM Ni nitrate (Ni(NO₃)₂) solution. As can be seen in FIG. 4, the carbon nanotubes show a high hydrogen desorption capacity of up to about 2.8 wt % at atmospheric pressure and a temperature range of 70-220° C.

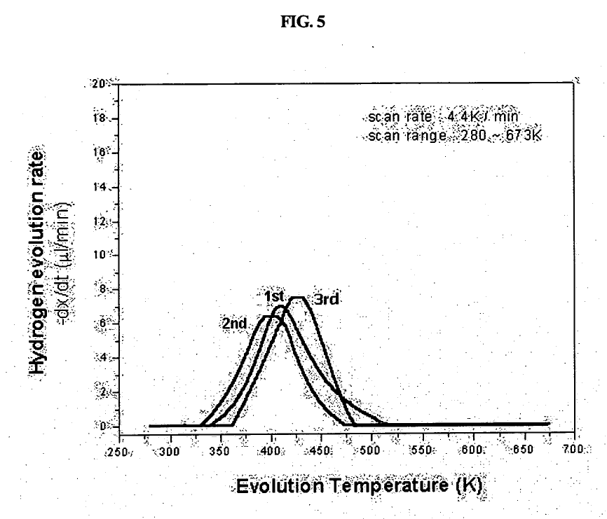

FIG. 5 shows 3 cycles of hydrogen desorption characteristics for carbon nanotubes doped with 6 wt % Ni using a 10 mM Ni nitrate (Ni(NO₃)₂) solution. As can be seen in FIG. 5, nanosized nickel functions to increase the reversible hydrogen absorption and desorption of carbon nanotubes.

The present invention relates to the development of a hydrogen storage material for hydrogen fuel cell systems, and more particularly, the development of a material having high hydrogen storage capacity under conditions of room temperature and atmospheric pressure. The material developed according to the present invention can be used as a hydrogen storage material for hydrogen fuel cell systems, and more particularly, hydrogen fuel cell systems for automobiles. This can advance the development and popularization of hydrogen fuel cell automobiles.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A method for producing nanosized nickel-doped carbon nanotubes for hydrogen storage, the method comprising:
sonicating carbon nanotube samples produced by a vapor deposition process, in sulfuric acid solution, followed by filtration, so as to remove a metal catalyst from the carbon nanotube samples; and
doping the carbon nanotube samples using a liquid phase process, followed by drying and reduction, so as to dope nanosized nickel on the surface of the carbon nanotubes.

2. The method of claim 1, wherein the doping step is performed by impregnating the carbon nanotube samples in a solution containing Ni(NO₃)₂ or a solution containing NiCl₂.6H₂O and a surfactant using a liquid phase process, and reducing the carbon nanotube solution, followed by washing and drying.

3. The method of claim 1, wherein the vapor deposition process is a thermal chemical vapor deposition process in which the carbon nanotube samples are produced using argon/hydrogen (Ar/H₂) as reaction gases at a temperature of 800° C. and a pressure range of 100-760 torr with the feeding of a carbon source material and a catalyst material (0.04 g ferrocene per ml of xylene).

4. The method of claim 1, wherein the vapor deposition process is a plasma enhanced chemical vapor deposition process in which the carbon nanotube samples are produced using a mixed gas consisting of 0.1% methane (CH₄), 89.9% hydrogen (H₂) and 10% oxygen (O₂), at a temperature of 750° C., a pressure of 30 torr and a microwave power of 700 W.

5. The method of claim 1, wherein the sonicating comprises sonicating the carbon nanotube samples in 70% sulfuric acid solution for 3 hours, followed by filtration through a filter, so as to remove the metal catalyst from the carbon nanotube samples.

6. The method of claim 1, wherein the doping step is performed by impregnating 0.1 g of the carbon nanotube samples in 200 ml of acetone solution containing 5 to 73 mM Ni(NO₃)₂, stirring the carbon nanotube solution for 3 hours, drying the stirred solution at 60° C., and reducing the dried carbon nanotube samples in a hydrogen atmosphere at 300° C. for 3 hours, so as to produce carbon nanotubes having nanosized nickel doped on the surface thereof.

7. The method of claim 2, wherein the doping step is performed by impregnating 0.1 g of the carbon nanotube samples in 200 ml of acetone solution containing 5 to 73 mM Ni(NO₃)₂, stirring the carbon nanotube solution for 3 hours, drying the stirred solution at 60° C., and reducing the dried carbon nanotube samples in a hydrogen atmosphere at 300° C. for 3 hours, so as to produce carbon nanotubes having nanosized nickel doped on the surface thereof.

8. The method of claim 1, wherein the doping step is performed by impregnating 0.1 g of the carbon nanotube samples in 100 ml of distilled water solution containing 5 to 73 mM NiCl₂.6H₂O and a surfactant (Na₃C₆H₅O₇.2H₂O), stirring the carbon nanotube solution for 24 hours, and reducing the stirred carbon nanotube solution with 1M NaBH₄ solution, followed by drying and washing, so as to produce carbon nanotubes having nanosized nickel doped on the surface thereof.

9. The method of claim 2, wherein the doping step is performed by impregnating 0.1 g of the carbon nanotube samples in 100 ml of distilled water solution containing 5 to 73 mM NiCl₂.6H₂O and a surfactant (Na₃C₆H₅O₇.2H₂O), stirring the carbon nanotube solution for 24 hours, and reducing the stirred carbon nanotube solution with 1M NaBH₄ solution, followed by drying and washing, so as to produce carbon nanotubes having nanosized nickel doped on the surface thereof.

10. Nanosized nickel-doped carbon nanotubes produced using a method as set forth in claim 1.

11. The carbon nanotubes of claim 10, wherein the amount of the nickel doped on the surface of the carbon nanotubes is 1 wt % to 99 wt % based on the weight of the carbon nanotubes.

12. The carbon nanotubes of claim 10, wherein the nickel doped on the surface of the carbon nanotubes has a particle size of 1 nm to 1 μm.
